(19) United States
(12) Patent Application Publication
(10) Pub. No.: US 2012/0154235 A1
(43) Pub. Date: Jun. 21, 2012

(54) CIRCULARLY POLARISED ANTENNA

(75) Inventors: Akira Nakamura, Ebina-shi (JP); Hiroki Yoshioka, Kawasaki-shi (JP)

(73) Assignee: Mitsumi Electric Co. Ltd., Tama-shi, Tokyo (JP)

(21) Appl. No.: 13/392,579

(22) PCT Filed: Aug. 2, 2010
(86) PCT No.: PCT/JP2010/062994

§ 371 Date: Feb. 27, 2012

(30) Foreign Application Priority Data
Aug. 27, 2009 (JP) 2009-196296

(51) Int. Cl. H01Q 1/38

(52) U.S. Cl. 343/787

(57) ABSTRACT

A circularly polarised patch antenna includes: an antenna electrode; a ground section; a substrate, which is sandwiched between the antenna electrode and the ground section and which has insulating properties, a predetermined dielectric constant and single-axis magnetic anisotropy for a plurality of different magnetization directions; and a power feed pin which is electrically connected to the antenna electrode.

### TECHNICAL FIELD

The present invention relates to a circularly polarised antenna.

### BACKGROUND ART

Heretofore, as an antenna for communication in a high frequency band, a patch antenna has been known. The patch antenna is used as an on-board global positioning system (GPS) antenna or an on-board electronic toll collection system (ETC) antenna.

Features of the patch antenna are that a structure is simple, that fabrication is easy, that impedance matching is easy, and that a variety of polarization controls are easy. The patch antenna includes a ground plate, a substrate, an antenna electrode plate, and a power feed pin. The substrate is provided to be sandwiched between the antenna electrode plate and the ground plate. The power feed pin is electrically connected to the antenna electrode plate, and penetrates holes drilled in the substrate and the ground plate.

A material of the substrate is dielectric ceramics or the like. A dielectric constant of the substrate affects a resonant frequency of the patch antenna.

For example, a patch antenna for a GPS signal is installed in an inside of an automobile or the like. In order to reduce an installation space for the patch antenna, it is required that the patch antenna be miniaturized. Therefore, a substrate with a high dielectric constant is used for the patch antenna, and such miniaturization of the patch antenna is achieved by a wavelength shortening effect.

Moreover, in the case where metal is present in the vicinity of the antenna, an induced current is generated in the metal, and radiation of an electromagnetic wave of the antenna has been inhibited. Therefore, an antenna has been known, which includes a magnetic material for a high frequency, and prevents an occurrence of an unnecessary induced current of the metal in the vicinity thereof (for example, refer to Patent Documents 1 and 2).

In the conventional patch antenna, in the case of using such a high dielectric constant material, decrease of radiation efficiency and band narrowing of antenna characteristics occur following this increase of the dielectric constant. As measures for solving this point, there has been a method for applying magnetism to the substrate by using the magnetism as in the above-described antenna, enhancing a shortening coefficient of wavelength corresponding to a product of the dielectric constant and magnetic permeability of this substrate, and miniaturizing the patch antenna.

### PRIOR ART DOCUMENTS

### Patent Document

Patent Document 1: JP-A-2009-59932

Patent Document 2: JP-A-2009-76652

### SUMMARY OF INVENTION

### Problem to be Solved by the Invention

In the conventional patch antenna including the substrate applied with the magnetism, in order to enhance the wavelength shortening effect brought by the magnetism, it is preferable to use a material with a small magnetic loss, and particularly, a uniaxial magnetic anisotropic material, for a magnetic material of the substrate. However, even in the case of simply using the uniaxial magnetic anisotropic material for the substrate, the patch antenna has not been able to radiate (receive) a circularly polarised wave such as a radio wave of the GPS signal or the like. Therefore, heretofore, with regard to such a circularly polarised patch antenna, an isotropic magnetic material with relatively low magnetic permeability has been able only to be used as the substrate.

It is an object of the present invention to realize miniaturization of the circularly polarised antenna, and in addition, to realize favorable radiation and reception of the circularly polarised wave.

### Means for Solving the Problem

In order to solve the above problem, a circularly polarised antenna according to the present invention includes:

an antenna electrode;

a ground;

a substrate configured to be sandwiched between the antenna electrode and the ground and having insulating properties, a predetermined dielectric constant, and plural uniaxial magnetic anisotropies in directions of easy axes of magnetization, each direction being different from one another; and

a power feeding unit electrically connected to the antenna electrode.

Preferably, in the circularly polarised antenna, the substrate includes:

plural magnetic dielectric portions, each having insulating property, predetermined dielectric constant and uniaxial magnetic anisotropy in predetermined direction of the easy axis of magnetization, and

each direction of the easy axis of magnetization of the magnetic dielectric portions is different from one another.

Preferably, in the circularly polarised antenna,

the substrate includes:

a dielectric portion made of a dielectric; and

plural magnetic layers each having uniaxial magnetic anisotropy in predetermined direction of the easy axis of magnetization, the plural magnetic layers being formed on the dielectric portion, and

each direction of the easy axis of magnetization of the magnetic layers is different from one another.

Preferably, in the circularly polarised antenna,

a nonmagnetic insulating layer is provided between the magnetic layers adjacent to each other.

Preferably, in the circularly polarised antenna,

each direction of the easy axis of magnetization is any one of directions in which all of the easy axis of magnetization divide 360° equally.

Preferably, in the circularly polarised antenna,

at least two directions of the easy axes of magnetization are orthogonal to each other.

### Advantageous Effect of Invention

In accordance with the present invention, in the circularly polarised antenna, effects of the miniaturization thereof can be enhanced, and in addition, the radiation efficiency and the gain are enhanced, and the good radiation and reception of the circularly polarised wave can be realized.

### BRIEF DESCRIPTION OF THE DRAWINGS

FIG. 1 is a perspective view showing a configuration of a circularly polarised patch antenna of an embodiment according to the present invention.

FIG. 2 is a perspective view showing respective components of the circularly polarised patch antenna.

FIG. 3 is a view showing directions of easy axes of magnetization of magnetic dielectric portions of the embodiment.

FIG. 4 is a graph showing frequency characteristics of magnetic permeability of each of an isotropic magnetic material and a uniaxial magnetic anisotropic material in the circularly polarised patch antenna.

FIG. 5 is a plan view of the circularly polarised patch antenna.

FIG. 6 is a side view of the circularly polarised patch antenna.

FIG. 7 is a graph showing frequency characteristics of voltage standing wave ratios (VSWRs) in a circularly polarised patch antenna of a specific example of the embodiment, a circularly polarised patch antenna of an isotropic magnetic material, and a circularly polarised patch antenna made only of a dielectric.

FIG. 8 is a graph showing axial ratio frequency characteristics in the circularly polarised patch antenna of the specific example, the circularly polarised patch antenna of the isotropic magnetic material, and the circularly polarised patch antenna made only of the dielectric.

FIG. 9 is a cross-sectional view of a substrate of a modification example.

FIG. 10 is a view showing three directions of easy axes of magnetization of each magnetic dielectric portions.

### DESCRIPTION OF EMBODIMENTS

A description is made below in detail of an embodiment according to the present invention and a modification example thereof in this order with reference to the accompanying drawings. However, the scope of the invention is not limited to such illustrated examples.

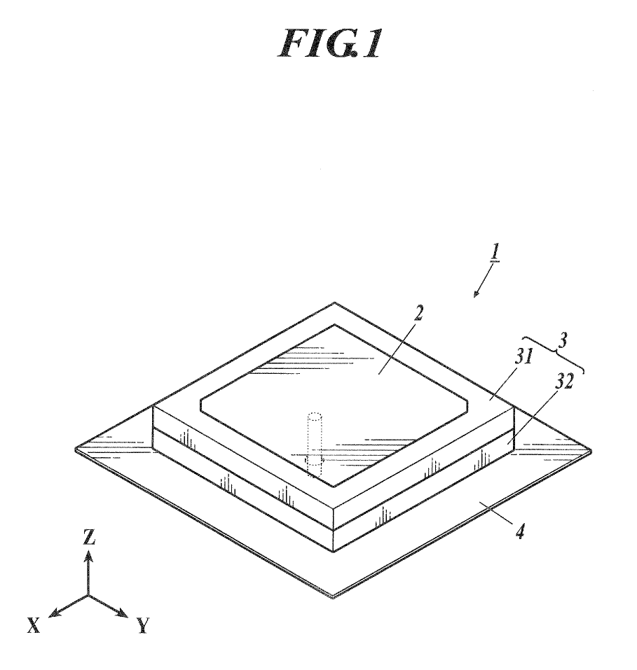

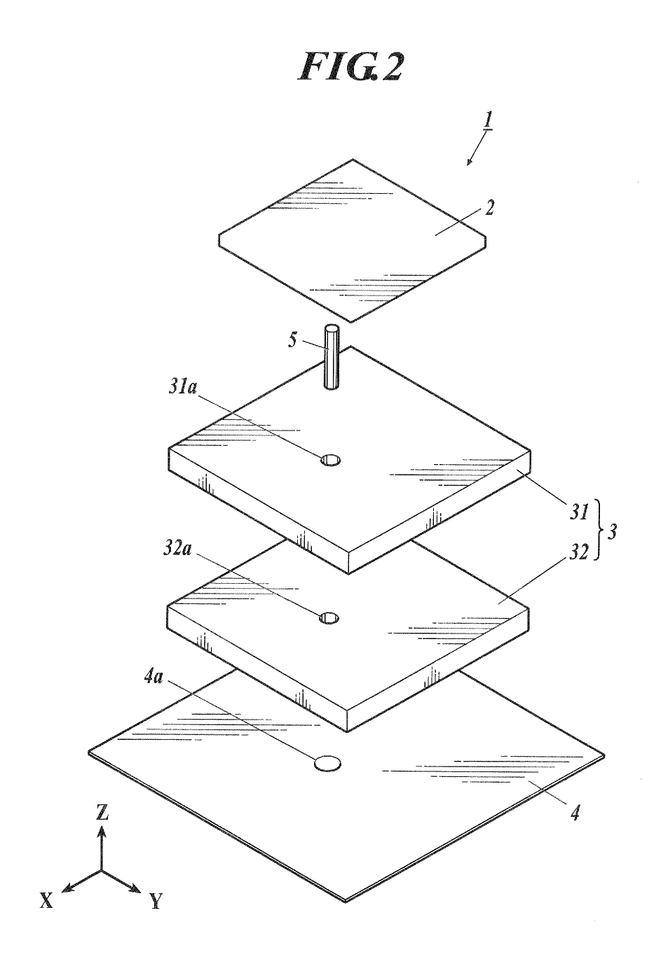

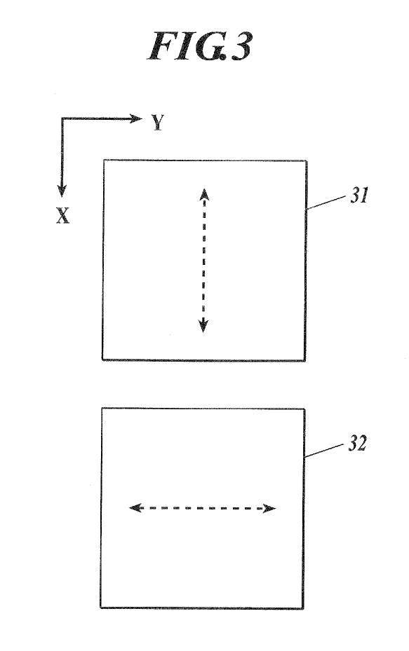

A description is made of the embodiment according to the present invention with reference to FIGS. 1 to 9. First, a description is made of a device configuration of a circularly polarised patch antenna 1 as a circularly polarised antenna of this embodiment with reference to FIG. 1 to FIG. 3. FIG. 1 shows a perspective configuration of the circularly polarised patch antenna 1. FIG. 2 shows the respective components of the circularly polarised patch antenna 1. FIG. 3 shows directions of easy axes of magnetization of magnetic dielectric portions 31 and 32 of the circularly polarised patch antenna 1.

It is assumed that the circularly polarised patch antenna 1 is a GPS antenna that receives a radio wave of a GPS signal from a GPS satellite. The radio wave of the GPS signal is a right-handed circularly polarised wave of 1.575 [GHz].

As shown in FIG. 1 and FIG. 2, the circularly polarised patch antenna 1 includes: an antenna electrode 2; a substrate 3; a ground 4; and a power feed pin 5. The substrate 3 has a magnetic dielectric portion 31 and a magnetic dielectric portion 32. The ground 4, the magnetic dielectric portion 32, the magnetic dielectric portion 31 and the antenna electrode 2 are stacked on one another in this order in a +Z-axis direction.

The antenna electrode 2 is a substantially square conductor plate of a metal conductor such as silver or copper. The antenna electrode 2 has a shape in which two notches (cuts) on diagonal corners are made on a square shape when viewed from an upper surface (plane of an X-axis and a Y-axis) thereof. The antenna electrode 2 is formed in such a manner that notches are made on a square antenna electrode for a linearly-polarised wave, and the antenna electrode 2 functions as an antenna electrode for a circularly polarised wave.

The magnetic dielectric portion 31 has a plate shape of a square larger than the antenna electrode 2 when viewed from an upper surface thereof. Moreover, the magnetic dielectric portion 31 has a hole 31a for inserting the power feed pin 5 therethrough when viewed from the upper surface. The hole 31a is provided at a position where impedance adjustment is made between a center portion and edge portion of the magnetic dielectric portion 31. The magnetic dielectric portion 32 has the same size and shape as those of the magnetic dielectric portion 31. Moreover, at the same position as in the hole 31a, the ground 4 has a hole 4a for inserting the power feed pin 5 therethrough. The power feed pin 5 is inserted into the ground 4 without contacting the hole 4a, and is then connected to a signal line (not shown).

Each of the magnetic dielectric portions 31 and 32 is a dielectric, and in addition, has magnetic anisotropy in one direction by being applied with magnetism. As shown in FIG. 3, each of the magnetic dielectric portions 31 and 32 has a magnetic anisotropy in different direction from each other. In FIG. 3, both of arrow broken lines indicate directions of easy axes of magnetization. The direction of the easy axis of magnetization of the magnetic dielectric portion 31 is the X-axis direction. The direction of the easy axis of magnetization of the magnetic dielectric portion 32 is the Y-axis direction. However, the directions of easy axes of magnetization of the magnetic dielectric portions 31 and 32 may be reverse to those in the example of FIG. 3, and just need to be orthogonal to each other.

Each of the magnetic dielectric portions 31 and 32 has, for example, a configuration in which a thin film material having magnetism is formed on a dielectric. It is necessary that this dielectric have insulating properties, have a small dielectric loss, and have an appropriate dielectric constant. This dielectric is a glass substrate, a plastic substrate, a ceramic substrate or the like. The dielectric is fabricated, for example, by molding.

Moreover, the above-described thin film material is, for example, an amorphous metal thin film, a granular thin film, or a patterned magnetic thin film. The amorphous metal thin film or the granular thin film is manufactured by magnetic deposition in a deposition process for the dielectric, or by magnetic annealing after a deposition process. The patterned magnetic thin film is applied with the magnetic anisotropy by a size effect brought by patterning the magnetic thin film. The reason why the thin film material is used for the magnetic dielectric portions 31 and 32 is that it is easy to control magnetic characteristics thereof, resulting in high industrial productivity. Moreover, in each of the magnetic dielectric portions 31 and 32, it is assumed that the magnetic thin film is formed on the upper surface (XY plane on the +Z-side) of the dielectric.

The magnetic dielectric portions 31 and 32 are adhered onto each other by an adhesive. Moreover, in place of this adhesive, a configuration using a double-sided tape may be adopted. It is necessary that these adhesive, double-sided tape and the like be nonmagnetic, have insulating properties, have a small dielectric loss, and have an appropriate dielectric constant, and further, have sufficient adhesive force.

The ground 4 is a conductor plate of a metal conductor such as silver and tin plates. In FIG. 2, the ground 4 has a shape larger than that of the magnetic dielectric portions 31 and 32 when viewed from an upper surface thereof. However, the ground 4 may be configured to be equivalent or a little smaller in area than the magnetic dielectric portions 31 and 32, and just needs to have an area necessary to favorably perform signal reception. Moreover, the ground 4 has a hole 4a for inserting the power feed pin 5 therethrough at a position corresponding to the hole 32a. Note that such a configuration may also be adopted, in which the ground 4 is not directly formed on the patch antenna, but a circuit board arranged under the patch antenna is used as a ground.

The power feed pin 5 is a conductor pin of a metal conductor such as copper on a surface of which tin (Sn) is plated. The power feed pin 5 is electrically connected to the antenna electrode 2, and in addition, is allowed to pass through the holes 31a and 32a and the hole 4a of the ground 4. The power feed pin 5 is provided so that an axial direction thereof can be a Z-axis direction. At a power feeding point, the power feed pin 5 is connected to a power feeding line of a coaxial feeder cable. Moreover, the ground 4 is connected to a shield line of the coaxial feeder cable.

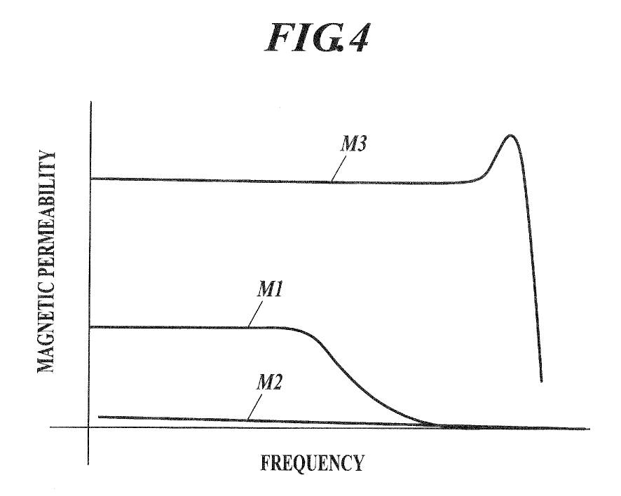

Subsequently, a description is made of magnetic permeability of each of the magnetic dielectric portions 31 and 32 with reference to FIG. 4. FIG. 4 shows frequency characteristics of magnetic permeability of each of an isotropic magnetic material and a uniaxial magnetic anisotropic material in the patch antenna.

As shown in FIG. 4, magnetic permeability with respect to a frequency of a radio wave in the case where the isotropic magnetic material is used for the substrate of the patch antenna is defined as magnetic permeability M1. Moreover, magnetic permeability in the direction of easy axis of magnetization with respect to the frequency of the radio wave in the case where the uniaxial magnetic anisotropic material is used for the substrate of the patch antenna is defined as magnetic permeability M2. Magnetic permeability in a direction of a hard axis of magnetization with respect to the frequency of the radio wave in the case where the uniaxial magnetic anisotropic material is used for the substrate of the patch antenna in the same way is defined as magnetic permeability M3.

In comparison with the magnetic permeability M1, the magnetic permeability M2 is lower. However, in comparison with the magnetic permeability M1, the magnetic permeability M3 is higher. Owing to the uniaxial anisotropy, the magnetic dielectric portion 31 as the uniaxial magnetic anisotropic material has high magnetic permeability and a low magnetic loss only in the Y-axis direction as the direction of the hard axis of magnetization. Moreover, the magnetic dielectric portion 32 as the uniaxial magnetic anisotropic material has high magnetic permeability and a low magnetic loss only in the X-axis direction as the direction of the hard axis of magnetization. Therefore, in the circularly polarised patch antenna 1, the shortening coefficient of wavelength in the Y-axis direction can be enhanced by the magnetic dielectric portion 31, and the shortening coefficient of wavelength in the X-axis direction can be enhanced by the magnetic dielectric portion 32. Each shortening coefficient of wavelength in the X-axis direction and Y-axis direction is enhanced, whereby dimensions in the X- and Y-axis directions of the circularly polarised patch antenna can be reduced.

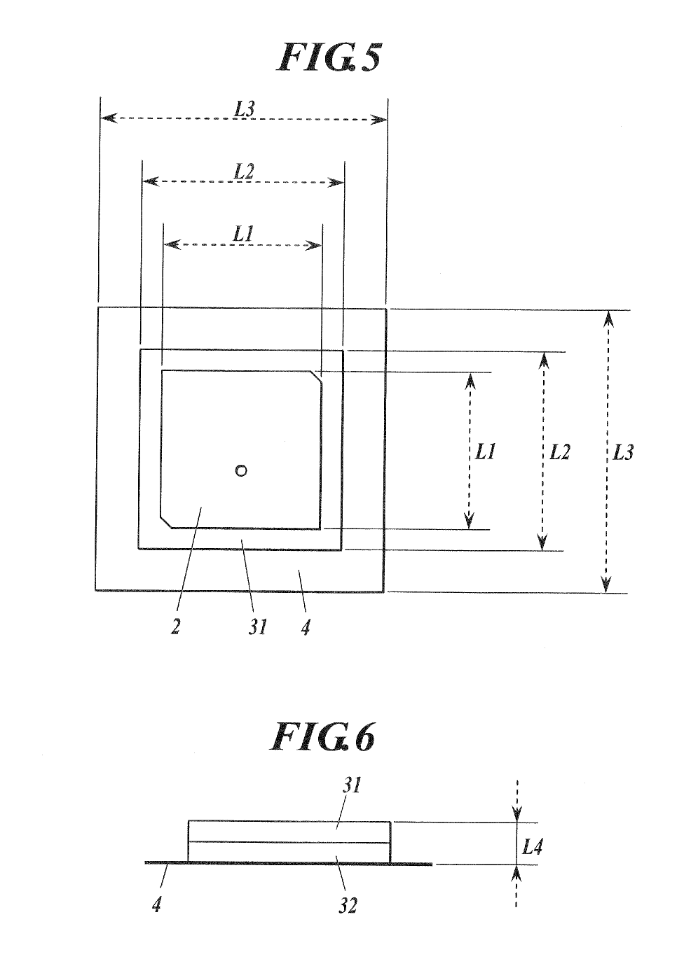

Subsequently, a description is made of dimensions of the circularly polarised patch antenna 1 with reference to FIG. 5 and FIG. 6. FIG. 5 shows a planar view of the circularly polarised patch antenna 1. FIG. 6 shows a side view of the circularly polarised patch antenna 1. Note that, in FIG. 6, the antenna electrode 2 is omitted.

As shown in FIG. 5, when a length of a side in the square of the plane of the antenna electrode 2 is defined as a length L1. Moreover, a length of a side in the square of the plane of each of the magnetic dielectric portions 31 and 32 is defined as a length L2. Furthermore, a length of a side in the square of the plane of the ground 4 is defined as a length L3. Moreover, as shown in FIG. 6, a thickness of the magnetic dielectric portions 31 and 32 is defined as a length L4.

Considering the wavelength shortening effect by the dielectric constant and magnetic permeability (relative dielectric constant and relative magnetic permeability) of the substrate 3, the length L1 is set at a half of a wavelength of a radio wave (radio wave of the GPS signal) of a communication target so that the circularly polarised antenna 1 can resonate by the radio wave. The length L2 is an arbitrary length larger than the length L1. The length L4 is an arbitrary length smaller than the length L1. Corresponding to the length L4, a thickness of each of the magnetic dielectric portions 31 and 32 is set equal to that of the other. In such a way, the circularly polarised wave is generated. However, even in the case where the thickness of each of the magnetic dielectric portions 31 and 32 is different from that of the other, the circularly polarised wave can also be generated by equalizing each product “magnetic permeability×thickness” of the magnetic dielectric portions 31 and 32 to that of the other. Moreover, such a configuration may be adopted, in which the thickness of each of the magnetic dielectric portions 31 and 32 is allowed to be different from that of the other, and each product “magnetic permeability x thickness” is allowed to differ between the magnetic dielectric portions 31 and 32, whereby an elliptically polarised wave is generated. The length L3 is set at an arbitrary length larger than the length L2 However, the length L3 may be set equal to or smaller than the length L2 (L3≦L2), and just needs to be sufficient for ensuring the area of the ground 4, which is enough to favorably perform the signal reception.

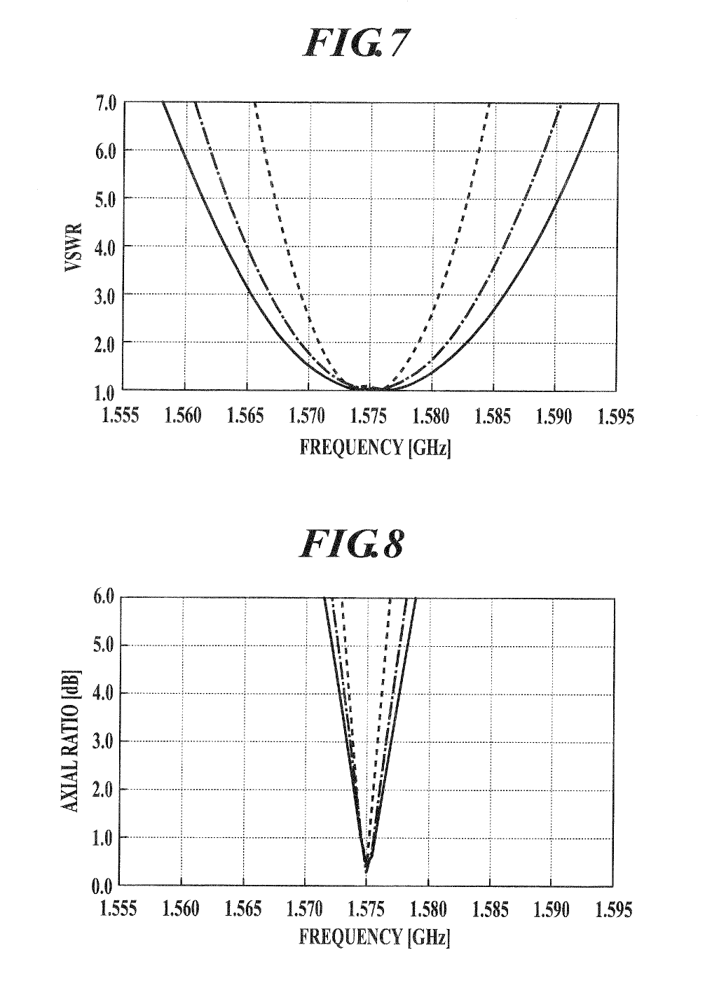

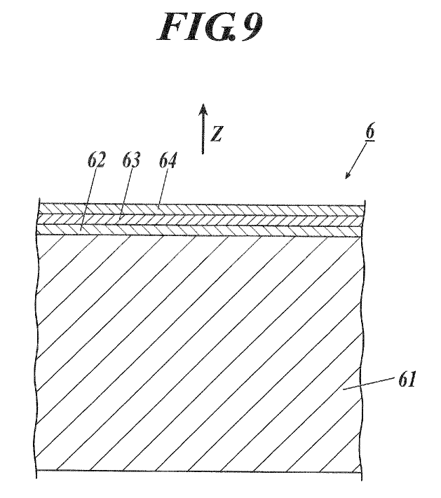

Next, a description is made of antenna characteristics with regard to one specific example of the circularly polarised patch antenna 1 with reference to FIG. 7 and FIG. 8. FIG. 7 shows frequency characteristics of VSWRs in the circularly polarised patch antenna 1 of the specific example, a circularly polarised patch antenna of an isotropic magnetic material, and a circularly polarised patch antenna made only of a dielectric. FIG. 8 shows axial ratio frequency characteristics in the circularly polarised patch antenna 1 of the specific example, the circularly polarised patch antenna of the isotropic magnetic material, and the circularly polarised patch antenna made only of the dielectric.

Simulation of the antenna characteristics was performed for the circularly polarised patch antenna 1 of the specific example. Here, the frequency f of the radio wave is set at 1.575 [GHz] corresponding to the GPS signal. The wavelength λ of the radio wave is 190.5 [mm], which is equal to c/f (c: speed of the radio wave). With regard to the circularly polarised patch antenna 1 of the specific example, the length L1 is set equal to 0.068 λ, the length L2 is set equal to 0.105 λ, and the length L3 is set equal to 0.263 λ.

Moreover, the relative dielectric constants of the X-axis, Y-axis and Z-axis of the substrate 3 are represented by (ε_{X}, ε_{Y}, ε_{Z}), and in the same way, the relative magnetic permeabilities of the X-axis, the Y-axis and the Z-axis are represented by (μ_{X}, μ_{Y}, μ_{Z}). With regard to the circularly polarised patch antenna 1 of the specific example, the relative dielectric constants (ε_{X}, ε_{Y}, ε_{Z}) of the magnetic dielectric portion 31 were set at (7.0, 7.0, 7.0), and in the same way, the relative magnetic permeabilities (μ_{X}, μ_{Y}, μ_{Z}) thereof were set at (1.2, 6.0, 1.2). In the same way, the relative dielectric constants (ε_{X}, ε_{Y}, ε_{Z}) of the magnetic dielectric portion 32 were set at (7.0, 7.0, 7.0), and in the same way, the relative magnetic permeabilities (μ_{X}, μ_{Y}, μ_{Z}) thereof were set at (6.0, 1.2, 1.2).

Furthermore, a description is made of two circularly polarised patch antennas to be compared with the circularly polarised patch antenna 1 of the specific example. One is a circularly polarised patch antenna in which the substrate is made only of a single dielectric (hereinafter, referred to as a circularly polarised patch antenna only of the dielectric). The other is a circularly polarised patch antenna in which the substrate is made of a single dielectric magnetic portion containing the isotropic magnetic material (hereinafter, referred to as a circularly polarised patch antenna of the isotropic magnetic material). It is assumed that, in each of the circularly polarised patch antenna only of the dielectric and the circularly polarised patch antenna of the isotropic magnetic material, dimensions of the antenna electrode, the substrate, the ground and the power feed pin are substantially the same as dimensions of the antenna electrode 2, the substrate 3 (magnetic dielectric portions 31, 32), the ground 4 and the power feed pin 5 in the circularly polarised patch antenna 1 of the specific example.

Moreover, it is assumed that, with regard to the substrate of the circularly polarised patch antenna only of the dielectric, a relative dielectric constant εᵣ thereof is equal to 50.0, and relative magnetic permeability μᵣ thereof is equal to 1.0 in the same way. Furthermore, it is assumed that, with regard to the substrate of the circularly polarised patch antenna of the isotropic magnetic material, a relative dielectric constant εᵣ thereof is equal to 17.0, and relative magnetic permeability μᵣ thereof is equal to 2.0 in the same way. Moreover, in FIG. 7 and FIG. 8, characteristics corresponding to the circularly polarised patch antenna of the specific example are shown by solid lines, characteristics corresponding to the circularly polarised patch antenna of the dielectric are shown by broken lines, and characteristics corresponding to the circularly polarised patch antenna of the isotropic magnetic material are shown by alternate long and short dashed lines.

Regarding the frequency characteristics of the VSWRs as shown in FIG. 7, the VSWRs of the antenna characteristics in the circularly polarised patch antenna 1 of the specific example, the circularly polarised patch antenna of the isotropic magnetic material and the circularly polarised patch antenna only of the dielectric are lowest in the vicinity of 1.575 [GHz]. Therefore, a result is obtained that resonant frequency in the circularly polarised patch antenna 1 of the specific example, the circularly polarised patch antenna only of the dielectric and the circularly polarised patch antenna made of the dielectric magnetic portion is 1.575 [GHz].

Then, when the VSWRs are equal to or smaller than 2 (VSWR≦2), each fractional bandwidth of the VSWRs in the circularly polarised patch antenna 1 of the specific example, the circularly polarised patch antenna of the isotropic magnetic material and the circularly polarised patch antenna only of the dielectric is 9.3%, 7.5% and 5.1% in this order. That is to say, such a relationship as follows was established: (the fractional bandwidth of the VSWR in the circularly polarised patch antenna 1)>(the fractional bandwidth of the VSWR in the circularly polarised patch antenna of the isotropic magnetic material)>(the fractional bandwidth of the VSWR in the circularly polarised patch antenna only of the dielectric). A result was obtained that the VSWR in the circularly polarised patch antenna 1 of the specific example has a widest band.

Regarding the axial ratio frequency characteristics as the antenna characteristics, as shown in FIG. 8, each axial ratio of the circularly polarised patch antenna 1 of the specific example, the circularly polarised patch antenna of the isotropic magnetic material, and the circularly polarised patch antenna only of the dielectric is lowest in the vicinity of 1.575 [GHz]. Therefore, a result was obtained that the circularly polarised patch antenna 1 of the specific example, the circularly polarised patch antenna only of the dielectric and the circularly polarised patch antenna made of the dielectric magnetic portion can radiate (receive) a circularly polarised wave with a best axial ratio at 1.575 [GHz].

Then, when the axial ratios are equal to or smaller than 3 (axial ratio≦3), each fractional bandwidth in the circularly polarised patch antenna 1 of the specific example, the circularly polarised patch antenna of the isotropic magnetic material and the circularly polarised patch antenna only of the dielectric is 2.3%, 1.9% and 1.2% in this order. That is to say, such a relationship as follows was established: (the fractional bandwidth of the axial ratio in the circularly polarised patch antenna 1)>(the fractional bandwidth of the axial ratio in the circularly polarised patch antenna of the isotropic magnetic material)>(the fractional bandwidth of the axial ratio in the circularly polarised patch antenna only of the dielectric). A result was obtained that the axial ratio in the circularly polarised patch antenna 1 of the specific example has a widest band.

Moreover, each radiation efficiency of the radio wave as the antenna characteristic in the circularly polarised patch antenna 1 of the specific example, the circularly polarised patch antenna of the isotropic magnetic material, and the circularly polarised patch antenna only of the dielectric is 71.4%, 60.0% and 50.0% in this order. That is to say, such a relationship as follows was established: (the radiation efficiency in the circularly polarised patch antenna 1)>(the radiation efficiency in the circularly polarised patch antenna of the isotropic magnetic material)>(the radiation efficiency in the circularly polarised patch antenna only of the dielectric). A result was obtained that the radiation efficiency in the circularly polarised patch antenna 1 of the specific example is highest.

Moreover, each zenith (+Z-axis direction) right-handed circularly polarised wave gains as the antenna characteristics in the circularly polarised patch antenna 1 of the specific example, the circularly polarised patch antenna of the isotropic magnetic material, and the circularly polarised patch antenna only of the dielectric is 2.51 [dBic], 1.75 [dBic] and 1.25 [dBic] in this order. That is to say, such a relationship as follows was established: (the zenith right-handed circularly polarised wave gain in the circularly polarised patch antenna 1)>(the zenith right-handed circularly polarised wave gain in the circularly polarised patch antenna of the isotropic magnetic material)>(the zenith right-handed circularly polarised wave gain in the circularly polarised patch antenna only of the dielectric). A result was obtained that the zenith right-handed circularly polarised wave gain in the circularly polarised patch antenna 1 of the specific example is highest.

As described above, in accordance with this embodiment, the circularly polarised patch antenna 1 includes the substrate 3 that has the insulating properties, the predetermined dielectric constant, and two uniaxial magnetic anisotropies each having a direction of the easy axis of magnetization, which is different from each other. The substrate 3 includes two magnetic dielectric portions 31 and 32 which are uniaxial magnetic anisotropic in directions of easy axes of magnetization, which are different from each other. Therefore, by large magnetic permeabilities in the directions of hard axes of magnetization, which are brought by the uniaxial magnetic anisotropic magnetic dielectric portions 31 and 32, the wavelength shortening effect can be enhanced, and the miniaturization of the circularly polarised patch antenna 1 can be realized. In addition to this, since the two directions of the easy axes of magnetization are different from each other, favorable radiation and reception of the circularly polarised wave can be realized. Specifically, the antenna characteristics (VSWR and axial ratio) of the circularly polarised patch antenna 1 can be widened in band, and the radiation efficiency of the radio wave and the circularly polarised wave gain can be enhanced.

Moreover, the two directions of the easy axes of magnetization of the magnetic dielectric portions 31 and 32 are orthogonal to each other, as directions in which the two easy axes of magnetization divide 360° equally. Therefore, the balance between the directions of the easy axes of magnetization is good, and more favorable radiation and reception of the circularly polarised wave can be realized.

### Modification Example

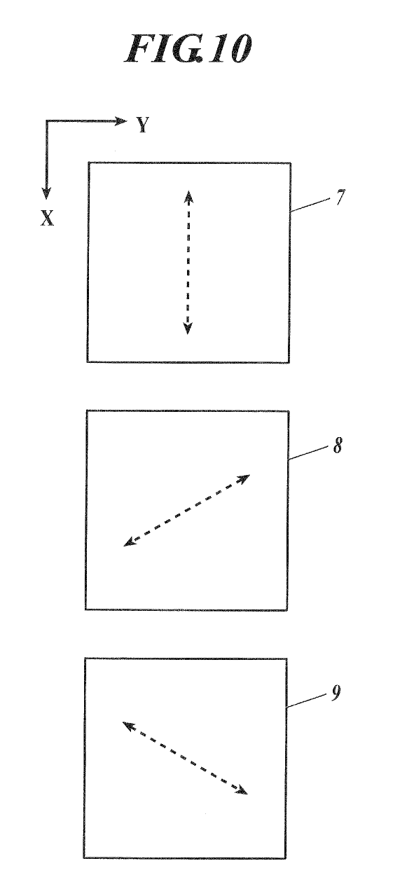

A description is made of a modification example of the above-described embodiment with reference to FIG. 9. FIG. 9 shows a cross-sectional view of the substrate 6 in this modification example.

A device configuration of this modification example is a configuration in which the substrate 3 (two pieces of the magnetic dielectric portions 31 and 32) in the circularly polarised patch antenna 1 in the above-described embodiment is replaced by one substrate 6. Therefore, a description is mainly made only of the substrate 6.

In a similar way to the substrate 3, the substrate 6 has a plate shape having a square plane. As shown in FIG. 9, the substrate 6 includes: a dielectric portion 61; a magnetic layer 62; a nonmagnetic insulating layer 63; and a magnetic layer 64. On an upper surface of the dielectric portion 61, the magnetic layer 62, the nonmagnetic insulating layer 63 and the magnetic layer 64 are stacked in the +Z-axis direction in this order.

The magnetic layer 62 is composed of a uniaxial magnetic anisotropic material similar to the thin films of the magnetic dielectric portions 31 and 32 having the thin films of the uniaxial magnetic anisotropic material. The nonmagnetic insulating layer 63 is composed of a nonmagnetic insulator of an oxide such as aluminium oxide, silicon oxide, or the like.

Moreover, it is assumed that, in the magnetic layer 62, a direction of the easy axis of magnetization therein has magnetism in the direction of the easy axis of magnetization of the magnetic dielectric portion 31 of FIG. 3 (X-axis direction) when viewed from an upper surface of the magnetic layer 62. It is assumed that, in the magnetic layer 64, a direction of the easy axis of magnetization therein has magnetism in the direction of the easy axis of magnetization of the magnetic dielectric portion 32 of FIG. 3 (Y-axis direction) when viewed from an upper surface of the magnetic layer 64. Furthermore, a configuration may be adopted, in which the magnetic layer 62, the nonmagnetic insulating layer 63 and the magnetic layer 64 are formed on a lower surface of the dielectric portion 61. Moreover, a configuration may be adopted, in which the magnetic layer 62 and the magnetic layer 64 are formed separately on the upper surface and lower surface of the dielectric portion 61.

As described above, in accordance with this modification example, the circularly polarised patch antenna includes the substrate 6 that has insulating properties, a predetermined dielectric constant, and plural uniaxial magnetic anisotropies each having a direction of the easy axis of magnetization, which are different from each other. The substrate 6 includes the dielectric portion 61, and two magnetic layers 62 and 64 which are uniaxial magnetic anisotropic in the directions of the easy axes of magnetization, which are different from each other. Therefore, by large magnetic permeabilities in the directions of hard axes of magnetization, which are brought by the uniaxial magnetic anisotropic magnetic layers 62 and 64, the wavelength shortening effect can be enhanced, and the miniaturization of the circularly polarised patch antenna can be realized. In addition to this, since the two directions of easy axes of magnetization are different from each other, favorable radiation and reception of the circularly polarised wave can be realized.

Moreover, the two directions of easy axes of magnetization of the magnetic layers 62 and 64 are orthogonal to each other, as directions in which the two easy axes of magnetization divide 360° equally. Therefore, the balance between the directions of easy axes of magnetization is good, and more favorable radiation and reception of the circularly polarised wave can be realized.

The substrate 6 includes the nonmagnetic insulating layer 63 between the magnetic layers 62 and 64 adjacent to each other. Therefore, magnetic characteristics of the substrate 6 can be prevented from being damaged by magnetism coupling of the magnetic layers 62 and 64 adjacent to each other.

Note that the description in the above-described embodiment and modification example shows merely examples of the circularly polarised antenna according to the present invention, and the present invention is not limited to this.

For example, at least two of the above-described embodiment and modification example and the following configuration may be appropriately combined with each other.

Moreover, in the above-described embodiment and modification example, the substrate of the circularly polarised patch antenna is composed as the substrate (magnetic dielectric portions 31 and 32 or substrate 6) in which the uniaxial magnetic anisotropic materials are formed as thin films on the dielectric. However, the present invention is not limited to this. For example, the substrate of the circularly polarised patch antenna may be a substrate having plural uniaxial magnetic anisotropic magnetic dielectric portions made of a bulk material or the like. The bulk material is a composite material in which magnetic particles made of metal or ferrite are dispersed into resin or into an inorganic dielectric. Moreover, the substrate of the circularly polarised patch antenna may be formed as a substrate including plural magnetic dielectric portions in each of which the uniaxial magnetic anisotropy is realized by providing permanent magnets on side surface portions of opposite sides on a plane of a dielectric.

Moreover, in the above-described embodiment, each of the magnetic dielectric portions 31 and 32 has a configuration in which the thin film of the uniaxial anisotropic material is formed on the upper surface of the dielectric. However, the present invention is not limited to this. For example, each of the magnetic dielectric portions 31 and 32 may have a configuration in which the thin film of the uniaxial anisotropic material is formed on the lower surface of the dielectric. Moreover, the magnetic dielectric portion 31 may have a configuration in which the thin film of the uniaxial anisotropic material is formed on the upper surface of the dielectric, and the magnetic dielectric portion 32 may have a configuration in which the thin film of the uniaxial anisotropic material is formed on the lower surface of the dielectric. Furthermore, the magnetic dielectric portion 31 may have a configuration in which the thin film of the uniaxial anisotropic material is formed on the lower surface of the dielectric, and the magnetic dielectric portion 32 may have a configuration in which the thin film of the uniaxial anisotropic material is formed on the upper surface of the dielectric. In such configurations, preferably, the magnetic dielectric portion 31 and the magnetic dielectric portion 32 are pasted to each other by a nonmagnetic insulating adhesive, double-sided tape or the like.

Moreover, in the above-described embodiment, it is assumed that the substrate of the circularly polarised patch antenna 1 is composed as the two-layer magnetic dielectric portions 31 and 32. However, the present invention is not limited to this. The substrate of the circularly polarised patch antenna may be allowed to have three or more layers, and the respective layers may be formed as magnetic dielectric portions having uniaxial anisotropies different in direction from one another.

Moreover, in the above-described modification example, a configuration is adopted, in which one layer as the substrate 6 composed of the magnetic layer 62, the nonmagnetic insulating layer 63 and the magnetic layer 64 is formed. However, the present invention is not limited to this. Such a configuration may also be adopted, in which a nonmagnetic insulating layer is formed on the magnetic layer 64 of the substrate 6, then the magnetic layer 62, the nonmagnetic insulating layer 63 and the magnetic layer 64 are further stacked thereon, and the magnetic layers 62 and 64 of the substrate 6 may be stacked to two or more layers.

Here, a description is made of a configuration in which the circularly polarised patch antenna 1 includes three magnetic dielectric portions 7, 8 and 9 in place of the two magnetic dielectric portions 31 and 32. FIG. 10 shows directions of easy axes of magnetization of the magnetic dielectric portions 7, 8 and 9.

It is assumed that the magnetic dielectric portions 7, 8 and 9 are stacked in this order in the +Z-axis direction of FIG. 1. The magnetic dielectric portions 7, 8 and 9 are pasted to one another by an adhesive. As shown in FIG. 10, the direction of the easy axis of magnetization of the magnetic dielectric portion 7 is the X-axis direction. The direction of the easy axis of magnetization of the magnetic dielectric portion 8 is a direction rotated counterclockwise by 120° from the direction of the axis (X-axis) of the easy magnetization of the magnetic dielectric portion 7. The direction of the easy axis of magnetization of the magnetic dielectric portion 9 is a direction rotated counterclockwise by 120° from the direction of the easy axis of magnetization of the magnetic dielectric portion 8.

That is to say, the directions of easy axes of magnetization of the magnetic dielectric portions 7, 8 and 9 are directions in which the easy axes of magnetization of all of the layers of the substrate divide 360° equally. Also with this configuration, the relative permeabilities in the directions of hard axes of magnetization can be enhanced, and the shortening coefficient of wavelength can be enhanced, whereby the miniaturization of the circularly polarised patch antenna 1 can be realized. Moreover, even in the case where the magnetic dielectric portions are four or more, preferably, such directions of easy axes of magnetization of the magnetic dielectric portions are directions different from one another in a similar way, and further, preferably, each direction of the easy axis of magnetization of the substrate is one of directions in which all of the easy axes of magnetization divide 360° equally. In a similar way, a configuration may be adopted, in which the number of the magnetic layers formed on the dielectric in the above-described modification example is set at three or more.

Moreover, in each of the above-described embodiment and modification example, the circularly polarised patch antenna is composed, which has the antenna electrode 2, the substrate 3 or 6 and the ground 4, which is square when viewed from the upper surface (X-Y plane). However, the present invention is not limited to this. For example, a circularly polarised patch antenna may be composed, which has an antenna electrode, a substrate and a ground, which have a shape such as a circular shape and a polygonal shape when viewed from an upper surface thereof.

Moreover, in each of the above-described embodiment and modification example, the radio wave for the communication of the circularly polarised patch antenna is the radio wave of the GPS signal. However, the present invention is not limited to this. For example, the radio wave for the communication of the circularly polarised patch antenna may be a radio wave of a right-handed circularly polarised wave with a frequency of 5.8 [GHz] for the ETC, which is other than 1.575 [GHz], or may be a radio wave of a left-handed circularly polarised wave with an arbitrary frequency.

Moreover, in each of the above-described embodiment and modification example, the power feeding to the antenna electrode is performed by the power feed pin 5. However, the present invention is not limited to this. For example, an electrode pattern for the power feeding may be formed on the substrate, and the power may be fed to the antenna electrode through this electrode pattern for the power feeding. Moreover, the power feeding may be performed by electromagnetic coupling without performing such direct power feeding. It is needless to say that the holes 31a and 32a formed for inserting the power feed pin 5 therethrough are unnecessary at this time.

Besides the above, detailed configurations and detailed operations of the circularly polarised patch antenna 1 in the above-described circularly polarised patch antenna 1 are also appropriately changeable within the scope without departing from the spirit of the present invention.

### INDUSTRIAL APPLICABILITY

As described above, the circularly polarised antenna according to the present invention is suitable for the radio wave communication of the circularly polarised wave in the GPS, the ETC and the like.

### EXPLANATION OF REFERENCE NUMERALS

1 CIRCULARLY POLARISED PATCH ANTENNA

2 ANTENNA ELECTRODE

3, 6 SUBSTRATE

31, 32 MAGNETIC DIELECTRIC PORTION

31a, 32a MAGNETIC DIELECTRIC PORTION

61 DIELECTRIC PORTION

62, 64 MAGNETIC LAYER

63 NONMAGNETIC INSULATING LAYER

7, 8, 9 MAGNETIC DIELECTRIC PORTION

4 GROUND

5 POWER FEED PIN

1. A circularly polarised antenna comprising:
an antenna electrode;
a ground;
a substrate configured to be sandwiched between the antenna electrode and the ground and having insulating properties, a predetermined dielectric constant, and plural uniaxial magnetic anisotropies in directions of easy axes of magnetization, each direction being different from one another; and
a power feeding unit electrically connected to the antenna electrode.

2. The circularly polarised antenna according to claim 1, wherein the substrate comprises:
plural magnetic dielectric portions, each having insulating property, predetermined dielectric constant and uniaxial magnetic anisotropy in predetermined direction of the easy axis of magnetization, and
each direction of the easy axis of magnetization of the magnetic dielectric portions is different from one another.

3. The circularly polarised antenna according to claim 1, wherein the substrate comprises:
a dielectric portion made of a dielectric; and
plural magnetic layers each having uniaxial magnetic anisotropy in predetermined direction of easy axis of magnetization, the plural magnetic layers being formed on the dielectric portion, and
each direction of the easy axis of magnetization of the magnetic layers is different from one another.

4. The circularly polarised antenna according to claim 3, wherein a nonmagnetic insulating layer is provided between the magnetic layers adjacent to each other.

5. The circularly polarised antenna according to claim 1, wherein each direction of the easy axis of magnetization is any one of directions in which all of the easy axes of magnetization divide 360° equally.

6. The circularly polarised antenna according to claim 1, wherein at least two directions of easy axes of magnetization are orthogonal to each other.
